(19) United States
(12) Patent Application Publication
(10) Pub. No.: US 2026/0163282 A1
(43) Pub. Date: Jun. 11, 2026

(54) MALE CONNECTOR ASSEMBLY CONFIGURED WITH MULTI-SECTION STRUCTURE AND OFFSET-DEFINED PROJECTION, AND MALE CONNECTOR AND CONNECTING TERMINAL THEREOF

(71) Applicant: Amphenol East Asia Limited Taiwan Branch (H.K.), New Taipei City (TW)

(72) Inventor: Sheng-Fen SANG, New Taipei City (TW)

(73) Assignee: Amphenol East Asia Limited Taiwan Branch (H.K.), New Taipei City (TW)

(21) Appl. No.: 19/407,803

(22) Filed: Dec. 3, 2025

(30) Foreign Application Priority Data
Dec. 10, 2024 (TW) 113213603
Dec. 20, 2024 (TW) 113214068
Jan. 21, 2025 (TW) 114200828

(51) Int. Cl. H01R 13/24; H01R 12/70; H01R 12/71; H01R 13/02; H01R 13/504; H01R 13/627

(52) U.S. Cl. CPC H01R 13/2492; H01R 12/7082; H01R 12/714; H01R 13/025; H01R 13/504; H01R 13/6273

(57) ABSTRACT

A male connector assembly configured with a multi-section structure and an offset-defined projection and a male connector thereof include a male-end base and at least one connecting terminal divided from top to bottom into a fixing portion to be fixed to a transmission line, an abutting portion to abut a circuit board's electrically conductive contact, and a middle section configured to be connected to the fixing portion and the abutting portion, and having the multi-section structure with extension sections. The fixing portion is completely within a projection extent defined by two extension sections that are spaced apart by the greatest horizontal distance therebetween, and close to one of the two extension sections. Since the fixing portion is within the projection extent, the downward pressure transmitted by the fixing portion is gradually transmitted to the abutting portion through each extension section so as to be gradually dispersed in the middle section.

### CROSS-REFERENCE TO RELATED PATENT APPLICATION

This non-provisional application claims priority to and the benefit of, under 35 U.S.C. § 119(a), Taiwan Patent Application No. 113213603, filed Dec. 10, 2024 in Taiwan; claims priority to and the benefit of, under 35 U.S.C. § 119(a), Taiwan Patent Application No. 113214068, filed Dec. 20, 2024 in Taiwan; and claims priority to and the benefit of, under 35 U.S.C. § 119(a), Taiwan Patent Application No. 114200828, filed Jan. 21, 2025 in Taiwan. The entire content of the above identified applications is incorporated herein by reference.

### FIELD

The present disclosure is related to a male connector assembly, and more particularly to a male connector assembly having at least one connecting terminal divided from top to bottom into a fixing portion, a middle section and an abutting portion, in which the middle section is a multi-section structure having a projection extent corresponding to the fixing portion.

### BACKGROUND

As used herein, the term “connector” refers generally to a connecting element that is used to transmit electronic signals and electric power, including its fitting(s), if any. The main function of a connector is to establish and maintain the connection between electrical circuits, and a connector not only is responsible for transmitting electricity, but also covers data transfer, and is therefore an important component of any modern electronic system, which, be it a mobile phone, computer, or large industrial machine, cannot carry out its basic functions without the required connectors.

As their uses and installation locations vary, connectors come in many types that are structurally different in order to adapt to and satisfy user needs. For example, good shielding performance can reduce electromagnetic interference, and emphasis may also be placed on the stability of insertion connection, durability, waterproof and dustproof properties, resistance to vibrations, and so on. It can be known from the above that, as an indispensable component of modern electronic systems, connectors have been evolving in design and application as technological innovations and changes in market demands have taken place. Accordingly, one of the issues addressed in the present disclosure is to develop a connector having a structure desired by the market.

### SUMMARY

In order to stand out in the competitive market, based on years of practical, professional experience in designing, processing, and manufacturing various power supplies and/or signal connectors, and the research spirit that strives for excellence, as a result of longtime research and experiments, a male connector assembly configured with a multi-section structure and offset-defined projection, and male connector and connecting terminal thereof are provided in the present disclosure.

Certain aspects of the present disclosure are directed to a connecting terminal divided from top to bottom into a fixing portion, a middle section and an abutting portion. The fixing portion is configured to be fixed to a transmission line. The abutting portion is configured to abut against an electrically conductive contact of a circuit board. The middle section is configured to be connected to the fixing portion and the abutting portion, and is provided with a plurality of bends to form a multi-section structure. The multi-section structure has a plurality of extension sections. Two of the extension sections that are spaced apart by the greatest horizontal distance therebetween define a projection extent. The fixing portion is completely within the projection extent and is close to one of the two extension sections. A wire fixing space is formed between the fixing portion and the other of the two extension sections and is for receiving the transmission line. In this way, since the fixing portion and the wire fixing space are within the projection extent, the space occupied by the connecting terminal can be effectively utilized. At the same time, the downward pressure transmitted by the fixing portion can be gradually transmitted to the abutting portion through each extension section of the multi-section structure, so that the pressure is gradually dispersed in the middle section, effectively avoiding stress concentration in a single area, thereby improving the durability and stability of the structure.

In certain embodiments, the plurality of extension sections include a plurality of vertical sections and at least one intermediate connecting section. Each of the plurality of vertical sections extends substantially along a vertical axis, and an angle between each of the plurality of vertical sections and the vertical axis is equal to or less than 10 degrees. Each of the at least one intermediate connecting section connects two adjacent ones of the plurality of vertical sections.

In certain embodiments, the middle section includes an upper connecting section connected between the fixing portion and the uppermost one of the plurality of vertical sections.

In certain embodiments, the middle section includes a lower connecting section connected between the abutting portion and the lowermost one of the plurality of vertical sections.

In certain embodiments, the fixing portion and the abutting portion are positioned to be passed through by the same vertical axis and in axial alignment in a three-dimensional space.

In certain embodiments, the wire fixing space and the abutting portion are positioned to be passed through by the same vertical axis in the three-dimensional space.

In certain embodiments, a vertical cross-sectional shape of the fixing portion extends substantially along a vertical axis.

In certain embodiments, a vertical cross-sectional shape of the abutting portion extends substantially along a transverse axis or a longitudinal axis, and a bottom surface of the abutting portion is configured to abut against the electrically conductive contact.

In certain embodiments, the abutting portion is completely within the projection extent.

Certain aspects of the present disclosure are directed to a male connector including a male-end base and at least one said connecting terminal. The connecting terminal is directly or indirectly fixed to the male-end base.

In certain embodiments, the male-end base includes a first base body and a second base body, the first base body is located under the second base body, and the first base body has a smaller cross-sectional area than the second base body.

In certain embodiments, the male connector further includes at least one metal barrel. Each of the at least one metal barrel is configured to be fixed to the male-end base, and a barrel space is formed in each of the at least one metal barrel and is for receiving at least one of the at least one connecting terminal.

In certain embodiments, each of the at least one metal barrel includes an upper barrel element provided therein with an upper barrel space, and a lower barrel element configured to be connected along a vertical axis with the upper barrel element. The upper barrel element is at an upper position, the lower barrel element is at a lower position, a lower barrel space is provided in the lower barrel element, and the upper barrel space and the lower barrel space communicate with each other to form the barrel space.

Certain aspects of the present disclosure are directed to a male connector assembly including a transmission line and said male connector. The fixing portion of the connecting terminal is electrically connected to the transmission line.

In certain embodiments, the transmission line includes: a center conductor configured to transmit electrical signals and be fixed to the fixing portion of the connecting terminal, and located in the wire fixing space; a first insulating layer configured to wrap around, or cover the exterior of, the center conductor; a metal braided layer provided on the exterior of the first insulating layer to provide grounding; and a second insulating layer configured to wrap around, or cover the exterior of, the metal braided layer.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1A schematically shows the inserting coupling of a connector pair according to certain embodiments in the present disclosure.

FIG. 1B is an exploded view of the connector pair according to certain embodiments in the present disclosure.

FIG. 2 is a cross-section view of the connector pair according to certain embodiments in the present disclosure.

FIG. 3 is an exploded view of a male connector according to certain embodiments in the present disclosure.

FIG. 4 is an exploded view of at least one metal barrel and at least one connecting terminal according to certain embodiments in the present disclosure.

FIG. 5 is a side view of a connecting terminal in a coaxial spatial configuration, shown along with the vertical axe of the coaxial spatial configuration, according to certain embodiments in the present disclosure.

FIG. 6 is a side view of a connecting terminal according to certain embodiments in the present disclosure, presenting also the projection extent of offset-defined projection and the multi-section structure.

FIG. 7 is a side view of a connecting terminal according to certain embodiments in the present disclosure.

FIG. 8 is a cross-section view of a transmission line, a connecting terminal, a metal barrel and a circuit board according to certain embodiments in the present disclosure.

FIG. 9 is a right side view of a metal barrel assembled with a transmission line and a connecting terminal according to certain embodiments in the present disclosure.

FIG. 10 is a cross-section view of adjacent metal barrels according to certain embodiments in the present disclosure.

FIG. 11 is a cross-section view of a lower barrel element assembled with a connecting terminal and a terminal block according to certain embodiments in the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the term “and/or” includes any and all combinations of one or more of the associated listed items. Titles or subtitles can be used herein for the convenience of a reader, which shall have no influence on the scope of the present disclosure.

The accompanying drawings are schematic and may not have been drawn to scale. The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, materials, objects, or the like, which are for distinguishing one component/material/object from another one only, and are not intended to, nor should be construed to impose any substantive limitations on the components, materials, objects, or the like. Directional terms (e.g., “front”, “rear”, “left”, “right”, “upper/top” and/or “lower/bottom”) are explanatory only and are not intended to be restrictive of the scope of the present disclosure.

As may be used herein, unless the context clearly dictates otherwise, the term “substantially” or “approximately” refers to, for example, a value, or an average of values, in an acceptable deviation range of a particular value recognized or decided by a person of ordinary skill in the art, taking into account any specific quantity of errors related to the measurement of the value that may be resulted from limitations of a measurement system or device. For example, “substantially” may indicate that the value is within, for example, ±5%, ±3%, ±1%, ±0.5% or ±0.1%, or one or more standard deviations, of the particular value.

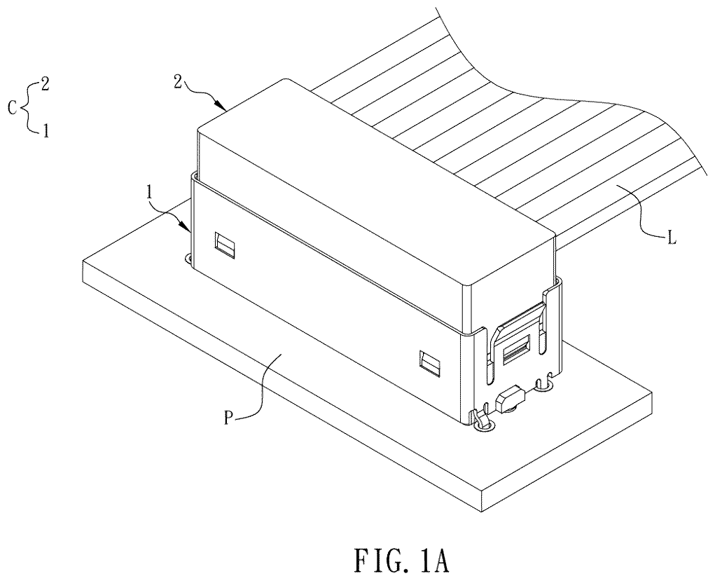

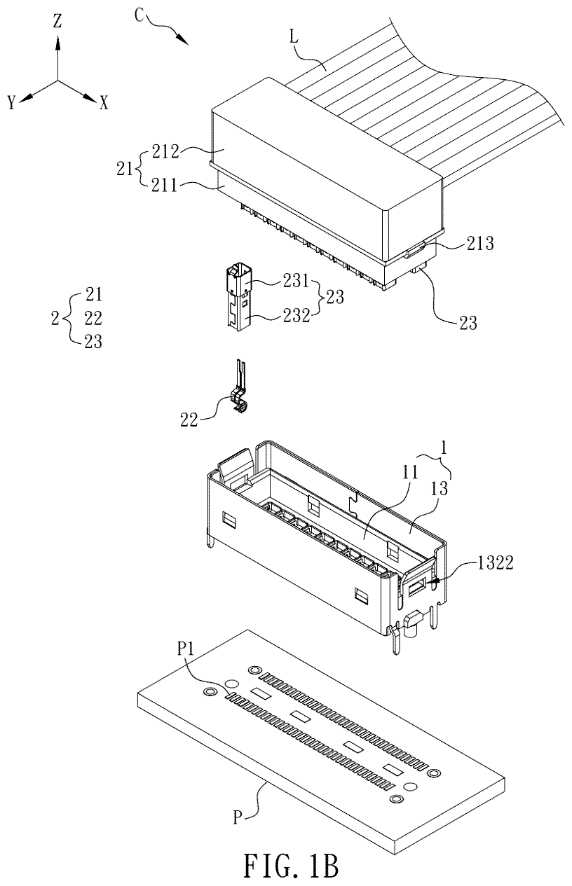

Certain aspects of the present disclosure are directed to a male connector assembly configured with a multi-section structure and an offset-defined projection, including a male connector 2 with at least one connecting terminal 22. The male connector assembly is used in a connector pair C to transmit signals or electricity for electronic equipment. The basic structure of the connector pair C is hereby introduced first. Referring to FIG. 1A and FIG. 1B, the connector pair C at least includes a female connector 1 and the male connector 2. The female connector 1 can be connected to a transmission carrier, and the male connector 2 can be connected to another transmission carrier. According to product requirements, the types of the two transmission carriers can be the same or different, and each can be a circuit board P, transmission line L, etc. After the female connector 1 and the male connector 2 are mated, electricity and/or signals can be transmitted between the two transmission carriers.

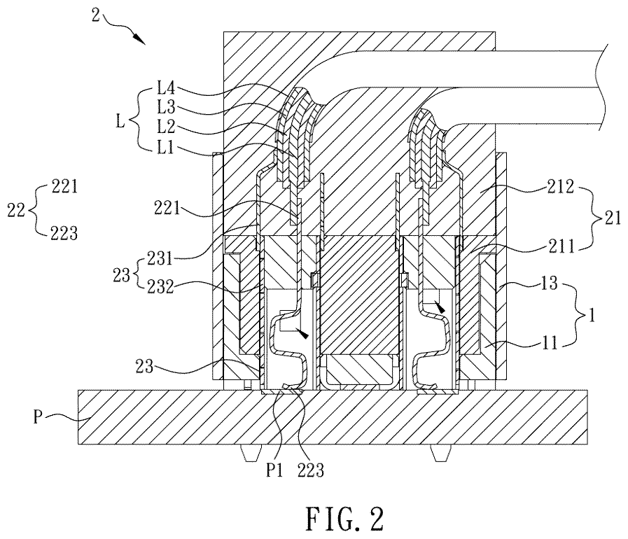

In certain embodiments, with continued reference to FIG. 1A and FIG. 1B, the female connector 1 includes a female-end insulating main body 11 and a female-end metal housing 13 and is provided on a circuit board P. The circuit board P is provided with a plurality of electrically conductive contacts P1. The male connector 2 is connected with a plurality of transmission lines L. As shown in FIG. 2, the transmission lines L are in the form of coaxial cables, each including a center conductor L1, a first insulating layer L2, a metal braided layer L3, and a second insulating layer L4. In each transmission line L, the center conductor L1 is used to transmit electrical signals; the first insulating layer L2 wraps around, or covers the exterior of, the center conductor L1; the metal braided layer L3 is provided on the exterior of the first insulating layer L2 to provide grounding and shielding; and the second insulating layer L4 wraps around, or covers the exterior of, the metal braided layer L3. However, in certain embodiments, depending on product requirements, the number of the transmission line(s) L can be one or more, and the form of the transmission line(s) L can be of other specifications and is not limited to the form of a coaxial cable. In addition, the number of the electrically conductive contact(s) P1 can be one or more, and can be the same or different from the number of the transmission line(s) L.

The structure and features of the male connector 2 is elaborated infra. To facilitate description of component features and relative positional relationship, the spatial configuration of the components as used in the present disclosure is defined by three axes that are perpendicular to one another, namely a transverse axis (the X axis), a longitudinal axis (the Y axis), and a vertical axis (the Z axis). Generally, unless the context clearly dictates otherwise, the transverse axis (the X axis) refers to the direction extending between the right and left sides, wherein the upper left of FIG. 1B is defined as facing the left side of a component, and the lower right of FIG. 1B as facing the right side of a component; the longitudinal axis (the Y axis) refers to the direction extending between the front and rear sides, wherein the lower left of FIG. 1B is defined as facing the front side of a component, and the upper right of FIG. 1B as facing the rear side of a component; and the vertical axis (the Z axis) refers to the direction extending between the top and bottom sides, wherein the top (upper) side of FIG. 1B is defined as facing the top side of a component, and the bottom side of FIG. 1B as facing the bottom (lower) side of a component.

Referring to FIG. 1A to FIG. 4, the male connector 2 includes a male-end base 21 and at least one connecting terminal 22. The male-end base 21 is made of an insulating material and directly or indirectly covers or encloses a partial portion of the connecting terminal 22 through an injection molding process, a tight fit, and/or another means. In certain embodiments, the male-end base 21 includes a first base body 211 and a second base body 212. The first base body 211 is located under the second base body 212, has a smaller cross-sectional area than the second base body 212, and does not cover or enclose the transmission line(s) L. The second base body 212, on the other hand, covers or encloses a partial portion of each transmission line L and a partial portion of the connecting terminal 22. However, the present disclosure is not limited thereto. In certain embodiments, male-end base 21 can be a single component or include three or more components, the volumes and shapes of the elements constituting the male-end base 21 can be determined according to product requirements without being limited to the configuration presented in the figures, and all the elements that cover or enclose a partial portion of the connecting terminal 22 can cover or enclose a partial portion of the connecting terminal 22 through the same means, or through respective different means, so as to improve design and production flexibility.

The way in which the male-end base 21 “directly or indirectly” covers or encloses a partial portion of the connecting terminal 22 is explained as follows. Referring to FIG. 1A to FIG. 4, in certain embodiments, the male connector 2 is provided with at least one metal barrel 23, and it is feasible to have one or more connecting terminals 22 located in a single metal barrel 23. The male-end base 21 can cover a partial portion of the periphery of the metal barrel 23 through an injection molding process, a tight fit, or another means. This structural configuration demonstrates how “the male-end base 21 ‘indirectly’ covers or encloses a partial portion of the connecting terminal 22” by making no direct contact but indirect contact with the connecting terminal 22 through the metal barrel 23. In certain embodiments, the male connector 2 can be dispensed with the metal barrel 23. A structural configuration in which “the male-end base 21 ‘directly’ covers or encloses a partial portion of the connecting terminal 22” entails direct contact between the male-end base 21 and a partial portion of the connecting terminal 22. In cases where the male connector 2 has a plurality of connecting terminals 22, the design of the male-end base 21 can effectively keep the connecting terminals 22 where they are arranged. The male-end base 21 also serves as a mating portion of the male connector 2 and can be inserted into the mating space in the female connector 1. The male-end base 21 can be further provided with a male-end snap-fit portion 213 (for example, a protrusion; however, the present disclosure is not limited thereto) for coupling with the corresponding snap-fit unit 1322 of the female connector 1, thereby ensuring secure insertion connection between the male connector 2 and the female connector 1, preventing the connecting terminal 22 from being shifted in position during the insertion connection process. A shift in position of the connecting terminal 22 will cause poor contact, among other problems. It should be pointed out that the term “mating portion” refers generally to an element insertable into the mating space, and that the mating portion is not limited to any special structure or configuration. Besides, the configuration of the male-end snap-fit portion 213 may vary with that of the snap-fit unit 1322, as long as the two match and couple with each other.

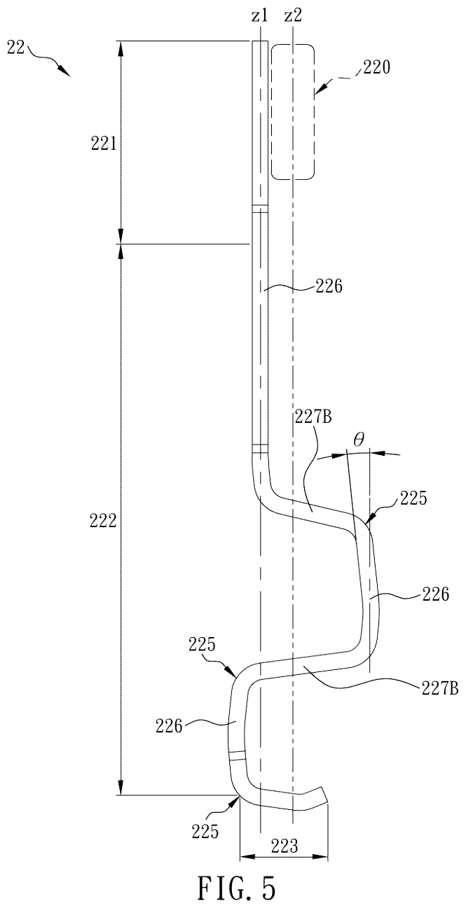

With continued reference to FIG. 1A to FIG. 4, the top end of the connecting terminal 22 is provided with a fixing portion 221, and the bottom end of the connecting terminal 22 is provide with an abutting portion 223. The fixing portion 221 is configured to be fixed to the center conductor L1 of the corresponding one of the transmission lines L (hereinafter referred to as the corresponding transmission line L). In certain embodiments, as the corresponding transmission line L is electrically connected to the connecting terminal 22 in a vertical direction, a vertical cross-sectional shape of the fixing portion 221 extends substantially along a vertical axis (see FIG. 5) to allow the fixing portion 221 to be easily soldered to the center conductor L1 of the corresponding transmission line L. However, the present disclosure is not limited thereto. In certain embodiments, the fixing portion 221 can be adjusted to other shapes according to actual needs. In addition, as the shape of the corresponding transmission line L changes, the position where the fixing portion 221 is fixed to the corresponding transmission line L can also be adjusted, as long as the fixing portion 221 can be electrically connected to the corresponding transmission line L and can transmit power and/or signals.

With continued reference to FIG. 1A to FIG. 4, the abutting portion 223 is configured to abut against the corresponding one of the electrically conductive contacts P1 (hereinafter referred to as the corresponding electrically conductive contact P1) of the circuit board P. In certain embodiments, as the circuit board P is located in a plane (XY plane) defined by a transverse axis (X axis) and a longitudinal axis (Y axis), a vertical cross-sectional shape of the abutting portion 223 extends substantially along the transverse axis or the longitudinal axis, as shown in FIG. 5, with the bottom surface of the abutting portion 223 configured to abut against the corresponding electrically conductive contact P1 on the circuit board P. When the abutting portion 223 is in an initial state (i.e., when the abutting portion 223 is not subjected to a downward pressing force), the vertical cross-sectional shape of the abutting portion 223 may be a horizontal, curved, or other shape extending in a left-right direction or a front-rear direction, but when the abutting portion 223 is subjected to a downward pressing force, its shape will be changed by the flat surface of the corresponding electrically conductive contact P1 such that the abutting portion 223 abuts against the corresponding electrically conductive contact P1 to transmit electricity and/or signals.

With continued reference to FIG. 1A to FIG. 4, when the male connector 2 is inserted into and thereby connected to the female connector 1, the connecting terminal 22 is subjected to a downward pressing force and thereby pressed tightly against the corresponding electrically conductive contact P1 to enable stable transmission of electricity and/or signals between the corresponding transmission line L and the circuit board P through the connecting terminal 22. Based on the above, to ensure that the connecting terminal 22 is structurally stable but still allows flexible structural adjustment, the structural configuration of the connecting terminal 22 includes, for example but not limited to, the following two.

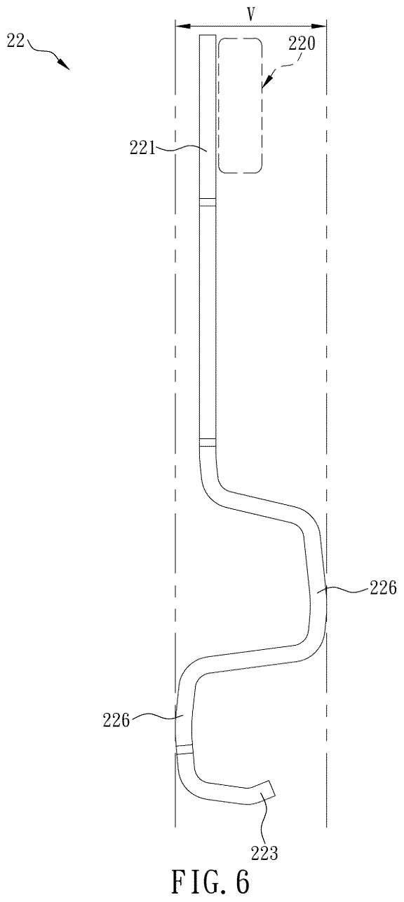

Referring to FIG. 2, FIG. 5, and FIG. 6, the first structural configuration is a configuration with “a multi-section structure and an offset-defined projection.” The middle section 222 of the connecting terminal 22 (i.e., the part of the connecting terminal 22 other than the fixing portion 221 and the abutting portion 223) is provided with a plurality of bends 225 to form a multi-section structure with a plurality of extension sections. In certain embodiments, the extension sections include a plurality of vertical sections 226 and a plurality of intermediate connecting sections 227B. Each vertical section 226 extends substantially along a vertical axis (Z axis). Each intermediate connecting section 227B connects two adjacent vertical sections 226. Preferably, each vertical section 226 is completely parallel to its respective vertical axis. Nevertheless, in actual production, as due to tolerances or design, the vertical sections 226 as defined in the present disclosure may be slightly tilted, and as long as the angle θ between a vertical section and its vertical axis is not greater than 10 degrees, it still falls in the definition of a vertical section 226 in the present disclosure.

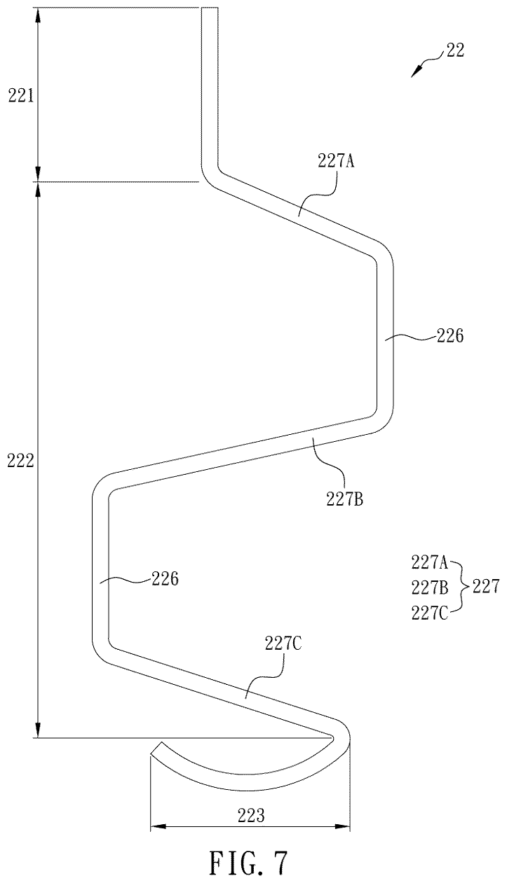

Referring to FIG. 5 in conjunction with FIG. 2, in certain embodiments, the fixing portion 221 is connected directly to the uppermost vertical section 226, and the abutting portion 223 is connected directly to the lowermost vertical section 226. The fixing portion 221 and the uppermost vertical section 226 extend along the same vertical axis z1 and form a straight line. However, the present disclosure is not limited thereto. In certain embodiments, referring to FIG. 7, there may be an upper connecting section 227A between the fixing portion 221 and the uppermost vertical section 226, and a lower connecting section 227C between the abutting portion 223 and the lowermost vertical section 226. Depending on product requirements, in certain embodiments, the connecting terminal 22 can be dispensed with the upper connecting section 227A and/or the lower supporting section 227C, and the fixing portion 221 may be directly connected to a vertical section 226, and/or the abutting portion 223 may be directly connected to a vertical section 226. In certain embodiments, when the fixing portion 221 and the vertical section 226 to which the fixing portion 221 is directly connected are both in the shape of a straight line and jointly form a straight portion, a top-end part of the straight portion can be identified as the fixing portion 221 while the rest of the straight portion is identified as the vertical section 226.

Referring to FIG. 6 in conjunction with FIG. 2 and FIG. 5, when the connecting terminal 22 is provided with two or more vertical sections 226, the two vertical sections 226 that are spaced apart by the greatest horizontal distance of all the horizontal distances between the two or more vertical sections 226 define a projection extent V. The projection extent V is defined by the portions of the two horizontally most widely spaced vertical sections 226 that have the greatest horizontal distance between them. The fixing portion 221 is completely within the projection extent V (which includes the edges of the projection extent V) and is close to one of the two horizontally most widely spaced vertical sections 226 (e.g., the leftmost vertical section 226 in FIG. 6) such that a wire fixing space 220 is formed between the fixing portion 221 and the other of the two horizontally most widely spaced vertical sections 226 (e.g., the rightmost vertical section 226 in FIG. 6). The wire fixing space 220 is used to receive the center conductor L1 of the corresponding transmission line L. In other words, the location where the fixing portion 221 and the corresponding transmission line L (or more particularly its center conductor L1) are fixed together is in the wire fixing space 220. Accordingly, with the fixing portion 221 being within the projection extent V and relatively close to one of the vertical sections 226 (i.e., offset in position), and the corresponding transmission line L (or more particularly its center conductor L1) located in the wire fixing space 220, the following effects can be achieved:
1. The downward pressing force transmitted through the fixing portion 221 goes sequentially through each extension section of the multi-section structure to the abutting portion 223 and is thereby gradually dissipated in the middle section 222 to effectively prevent stress concentration in a single area and enhance the durability and stability of the structure. In certain embodiments, it is feasible for the abutting portion 223 to be within the projection extent V as well to maintain a consistent direction of force in the fixing portion 221 and the abutting portion 223 of the connecting terminal 22. However, the present disclosure is not limited thereto.
2. The positional offset design of the fixing portion 221 allows the wire fixing space 220 to be located within the projection extent V, and this in turn allows the space occupied by the connecting terminal 22 to be effectively used. When the connecting terminal 22 is in the metal barrel 23, the offset design also ensures that the corresponding transmission line L (or more particularly its center conductor L1) is not too close to the metal barrel 23 to maintain good electrical performance.

Referring to FIG. 5 and FIG. 6 in conjunction with FIG. 2, the at least one connecting terminal 22 has both rigidity and elasticity and is capable of buffering and pressure absorption thanks to the vertical sections 226 and the plural connecting sections 227 (including the upper connecting section 227A (if existing), the intermediate connecting sections 227B, and the lower connecting section 227C (if existing)). The vertical sections 226 provide relatively high rigidity, enable a precise force transmission direction, and are therefore effective in reducing the energy loss caused by a change in direction of the transmitted force. The connecting sections 227 provide smooth transition of, and absorb, pressure to further enhance the mechanical performance of the structure, preventing the connecting terminal 22 from improper deformation or damage. In certain embodiments, the vertical section(s) 226 can be omitted and extension sections of various shapes, such as an arc or an oblique straight line (i.e., not extending along the vertical axis (Z axis) direction), can be adopted, as long as the projection extent formed by the two extension sections that are farthest apart in horizontal position among the multiple extension sections included in the multi-section structure can correspond to the fixing portion 221.

Referring to FIG. 5 in conjunction with FIG. 2, the second structural configuration is a “coaxial spatial configuration” in which, in terms of geometric relationship, the fixing portion 221 and the abutting portion 223 are positioned in a three-dimensional space in such a way that the same vertical axis z1 passes through a portion of the structure of each of them (see FIG. 5); in other words, the fixing portion 221 and the abutting portion 223 are arranged along the same vertical axis z1 and hence in axial alignment. Accordingly, when the connecting terminal 22 is subjected to an external force (e.g., a downward pressing force), the force will be transmitted along the vertical axis z1 in a concentrated manner, which minimizes uneven distribution and deviation of force to reduce such problems as deformation or breakage of the connecting terminal 22 and poor contact. When the abutting portion 223 is deformed by the downward pressing force (e.g., changed from a curved shape to a flat one), the support arising from the axial alignment of the fixing portion 221 and the abutting portion 223 allows the deformation to take place evenly in the direction of the vertical axis z1, ensuring a consistent direction of force in the fixing portion 221 and the abutting portion 223 of the connecting terminal 22 so that not only can the abutting portion 223 abut stably against the corresponding electrically conductive contact P1, but also the connecting terminal 22 is effectively kept from breakage or damage by local stress concentration that could otherwise occur in the bent portions of the connecting terminal 22.

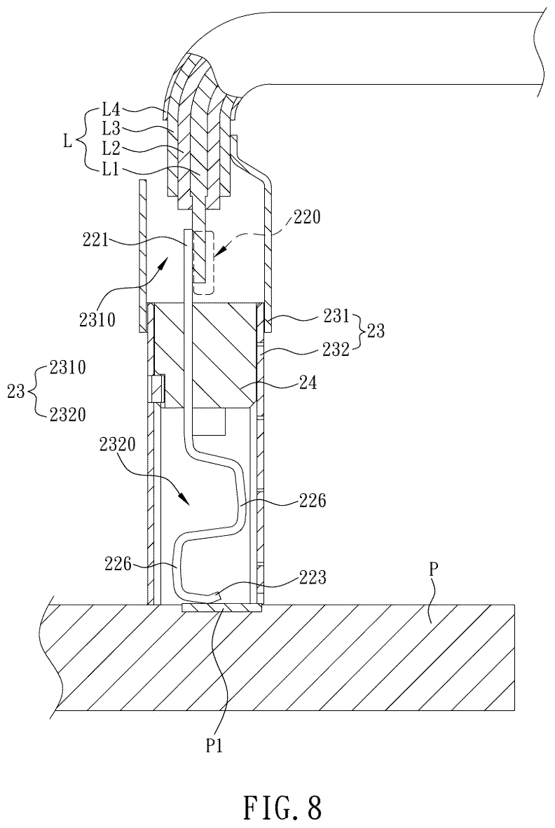

With continued reference to FIG. 5 in conjunction with FIG. 2, in certain embodiments, the wire fixing space 220 and the abutting portion 223 are arranged in a three-dimensional space in such a way that they are penetrated by the same vertical axis z2; that is to say, the wire fixing space 220 and the abutting portion 223 are in axial alignment along the vertical axis z2. Referring to FIG. 8, when the corresponding transmission line L (or more particularly its center conductor L1) is in the wire fixing space 220 and fixed to the fixing portion 221, the abutting portion 223 and the corresponding transmission line L (or more particularly its center conductor L1) are also axially aligned. Thus, the connecting terminal 22 and the corresponding transmission line L form a supporting relationship thanks to their high axial alignment and can be pressed downward and spring back along the same vertical path, which helps maintain a stable and uniform contact pressure and prevents local buckling or torsion under force. In applications that require repeated insertion and removal, or repeated elastic pressing and release, of the male connector 2, this structural configuration can effectively reduce the risk of fatigue or breakage of the connecting terminal 22. Accordingly, with the fixing portion 221 and the wire fixing space 220 axially aligned with the abutting portion 223 along the vertical axes z1 and z2 respectively, a coaxial double supporting structural design is achieved to further reduce the risk that the connecting terminal 22 may undergo torsion caused by a lateral force, experience stress concentration, or suffer from fatigue. It is noted that depending on product requirements, the connecting terminal(s) 22 can have a structure having both a “multi-section structure and offset-defined projection configuration” and a “coaxial spatial configuration”, or having only the “multi-section structure and offset-defined projection configuration.”

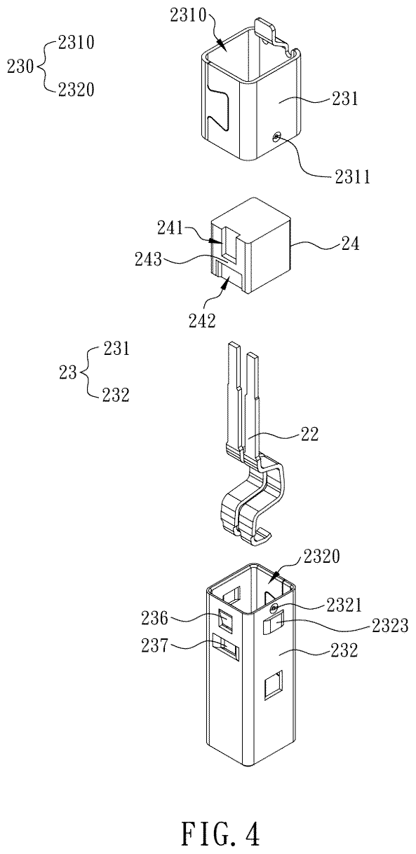

Referring to FIG. 1A to FIG. 3, in certain embodiments, the connecting terminal(s) 22 and the metal barrel(s) 23 can function as a male terminal assembly, and the connecting terminal(s) 22, the metal barrel(s) 23, and the corresponding transmission line(s) L can function as a male-end transmission assembly. When a connecting terminal 22 is provided in the corresponding metal barrel 23, which can effectively block off external electromagnetic interference, the foregoing architecture can protect signal transmission by the internal connecting terminal 22 and prevent signals from radiating from the connecting terminal 22 to the external environment, especially in high-frequency applications, thereby ensuring compliance with electromagnetic compatibility requirements. The metal barrel(s) 23 also provides desirable physical protection for the connecting terminal(s) 22 to extend their service life. As a connecting terminal 22 is relatively long and has to be fixed to the corresponding transmission line L during the production process, in certain embodiments, the convenience of production or assembly can be increased by the corresponding metal barrel 23 including an upper barrel element 231 and a lower barrel element 232, as shown in FIG. 4. The upper barrel element 231 is provided therein with an upper barrel space 2310, the lower barrel element 232 is provided therein with a lower barrel space 2320, and the upper barrel element 231 and the lower barrel element 232 are configured to be connected along a vertical axis such that the upper barrel element 231 is at an upper position while the lower barrel element 232 is at a lower position, with the upper barrel space 2310 and the lower barrel space 2320 communicating with each other to form a barrel space 230.

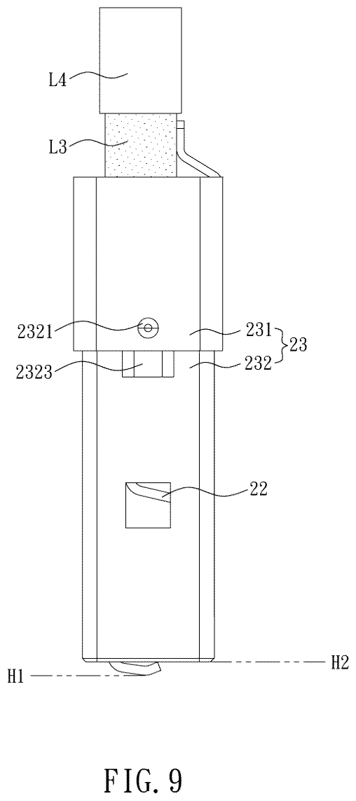

Referring to FIG. 1A to FIG. 4, in certain embodiments, two connecting terminals 22 can be provided in the barrel space 230 of a single metal barrel 23 without contact with the metal barrel 23. However, the present disclosure is not limited thereto. Depending on product requirements, a metal barrel 23 can accommodate one connecting terminal 22 or more than two connecting terminals 22. Further, when the connecting terminals 22 are in the metal barrel 23 but their abutting portions 223 have yet to abut against their respective corresponding electrically conductive contacts P1, referring to FIG. 9, the elevation H1 of the bottom sides of the abutting portions 223 is lower than the elevation H2 of the bottom side of the lower barrel element 232. In other words, when viewed from the side, the bottom ends of the connecting terminals 22 protrude from the bottom end of the lower barrel element 232. As the connecting terminals 22 are elastic, the abutting portions 223 will be pushed into the barrel space 230 after abutting against their respective corresponding electrically conductive contacts P1 and end up tightly pressed against the electrically conductive contacts P1. In certain embodiments, depending on product requirements, the elevation H1 of the bottom sides of the abutting portions 223 can flush with the elevation H2 of the bottom side of the lower barrel element 232, so that the abutting portions 223 can abut against the electrically conductive contacts P1 without being blocked by the lower barrel element 232. In certain embodiments, when the female connector 1 is in a form with female terminals, the abutting portions 223 can be brought into contact with their respective corresponding female terminals. In other words, the abutting portions 223 do not necessarily abut against their respective corresponding electrically conductive contacts P1; the abutting portions 223 may contact electrical connection members of various forms (e.g., electrically conductive contacts P1 or female terminals).

Referring to FIG. 1A to FIG. 4, in certain embodiments, the upper barrel element 231 is configured to be fixed to the corresponding transmission line L, with the upper barrel space 2310 corresponding to the fixing portion(s) 221 of the connecting terminal(s) 22 and the center conductor(s) L1 of the corresponding transmission line(s) L. To make it easy to observe and handle the connection relationship between the fixing portion(s) 221 and the center conductor(s) L1, the height (i.e., vertical dimension) of the upper barrel element 231 can be less than the height (i.e., vertical dimension) of the lower barrel element 232. However, the present disclosure is not limited thereto. In certain embodiments, if it is required to provide the upper barrel element 231 with an additional structure or element, the height (i.e., vertical dimension) of the upper barrel element 231 can be equal to or greater than the height (i.e., vertical dimension) of the lower barrel element 232, so as to improve production and design flexibility.

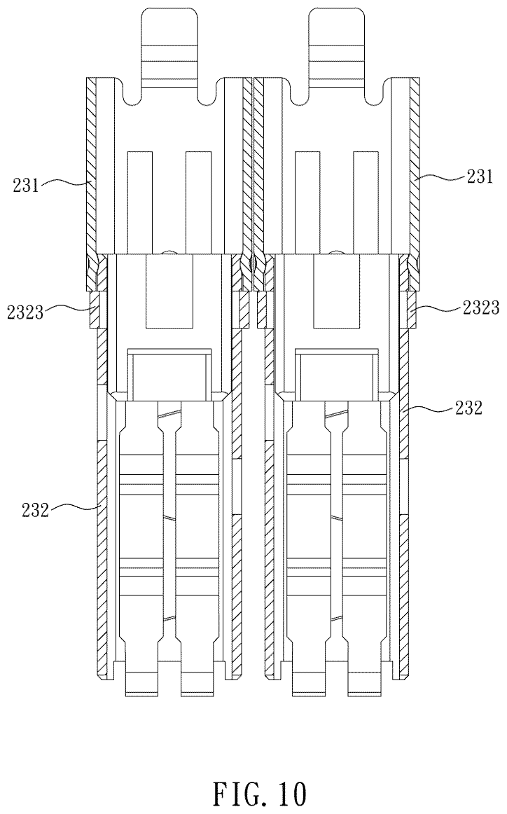

Referring to FIG. 10, which shows two metal barrels 23, in certain embodiments, the inner width of each upper barrel element 231 can be greater than or equal to the outer width of the corresponding lower barrel element 232 so that the top end of each lower barrel element 232 can be inserted into the corresponding upper barrel element 231 to make the two corresponding barrel elements partially overlap. Further, to establish a reliable assembled relationship, each upper barrel element 231 is provided with an upper positioning portion 2311 while the corresponding lower barrel element 232 is provided with a lower positioning portion 2321 (see FIG. 4), wherein the upper positioning portion 2311 can be an inwardly protruding bump while the lower positioning portion 2321 can be an inwardly extending recess. Each upper barrel element 231 and the corresponding lower barrel element 232 can be securely put together by coupling their upper and lower positioning portions. However, the present disclosure is not limited thereto. In certain embodiments, each upper barrel element 231 and the corresponding lower barrel element 232 can be coupled together through a tight fit, by soldering, or by laser welding if they do not have overlapping areas. To keep each upper barrel element 231 and the corresponding lower barrel element 232 at their intended assembled positions with respect to each other, each lower barrel element 232 may be provided with at least one protruding position-limiting portion 2323 (see FIG. 4), and the top end of each lower barrel element 232 may be configured to extend into the corresponding upper barrel element 231 until the bottom edge of the upper barrel element 231 abuts against the position-limiting portion 2323, preventing the lower barrel element 232 from extending too far into the upper barrel element 231.

While the metal barrel in previous embodiments is of multiple components, depending on product design requirements, in certain embodiments, each metal barrel may also be designed as a one-piece barrel whose internal barrel space is divided into an upper barrel space and a lower barrel space, with the upper barrel space accommodating the fixing portion(s) of the corresponding connecting terminal(s), and the lower barrel space accommodating the remaining portion(s) of the corresponding connecting terminal(s), wherein the upper barrel space has a greater width than the lower barrel space in the transverse-axis or longitudinal-axis direction. The structural design with a wider upper barrel space helps increase the operating space; makes it easy to put together, solder together, or perform other operations on each connecting terminal and the corresponding transmission line; effectively reduces the accumulation of heat between the connecting terminal(s) and the corresponding transmission line(s); and thereby enhances thermal stability of the structure.

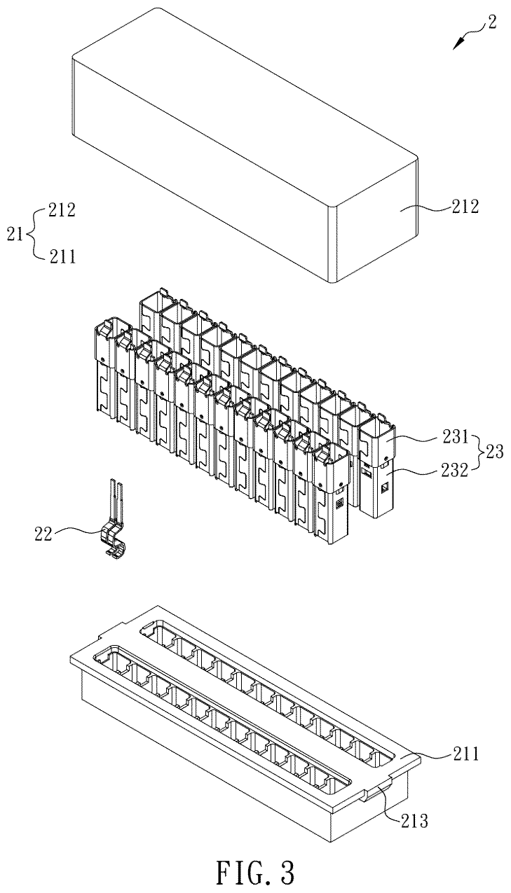

To ensure that each connecting terminal 22 can be firmly mounted into the corresponding metal barrel 23 and stay at the intended position, referring to FIG. 4 in conjunction with FIG. 2 and FIG. 3, each metal barrel 23 may have a terminal block 24 provided therefor, with at least one connecting terminal 22 fixed to the terminal block 24, wherein the terminal block 24 does not cover the fixing portion 221 of the connecting terminal 22 and allows the connecting terminal 22 and the corresponding transmission line L to be connected, or have their secureness inspected (the present disclosure is not limited thereto), with ease in a subsequent procedure, and wherein the terminal block 24 can be mounted, along with the connecting terminal 22 fixed thereto, into the metal barrel 23. Each terminal block 24 is provided with an upper block-end mounting groove 241 and a lower block-end mounting groove 242, wherein the upper block-end mounting groove 241 extends downward from the top side of the terminal block 24, is sunken into the terminal block 24, and forms an opening in one side (e.g., the front/rear/left/right side) of the terminal block 24. In FIG. 4, the upper block-end mounting groove 241 is sunken into the front side of the terminal block 24. The lower block-end mounting groove 242 of each terminal block 24 extends upward from the bottom side of the terminal block 24, is sunken into the terminal block 24, and forms an opening in one side (e.g., the front/rear/left/right side) of the terminal block 24. In FIG. 4, the lower block-end mounting groove 242 is sunken into the front side of the terminal block 24.

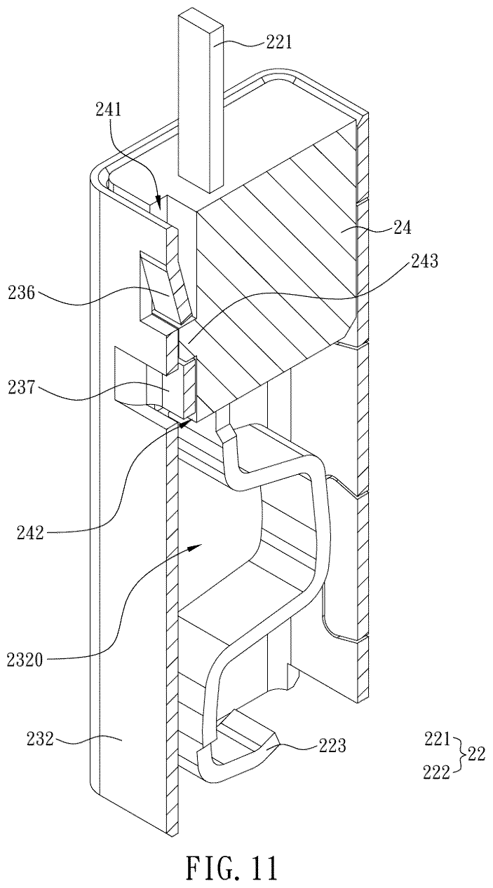

Referring to FIG. 4 and FIG. 11 in conjunction with FIG. 2 and FIG. 3, each metal barrel 23 is provided with a first barrel-end mounting portion 236 and a second barrel-end mounting portion 237. In certain embodiments, by way of example only, it is the lower barrel element 232 of each metal barrel 23 that is provided with the first barrel-end mounting portion 236 and the second barrel-end mounting portion 237. The first barrel-end mounting portion 236 of each metal barrel 23 is configured to be mounted to the upper block-end mounting groove 241 of the corresponding terminal block 24, and the second barrel-end mounting portion 237 of each metal barrel 23 is configured to be mounted to the lower block-end mounting groove 242 of the corresponding terminal block 24. Each first barrel-end mounting portion 236 can be an elastic plate, be formed by cutting or stamping a portion of the corresponding lower barrel element 232, and extend into the lower barrel space 2320 of the corresponding lower barrel element 232. Each second barrel-end mounting portion 237 can be a projecting member and formed by stamping a portion of the corresponding lower barrel element 232 inward. When a terminal block 24 is mounted into the corresponding metal barrel 23 in the downward direction, the free end of the elastic plate (i.e., the first barrel-end mounting portion 236) of the metal barrel 23 extends into the lower block-end mounting groove 242 of the terminal block 24; is then blocked, compressed, and consequently deformed by the dividing wall 243 between the upper block-end mounting groove 241 and the lower block-end mounting groove 242 of the terminal block 24; and after moving past the dividing wall 243, is engaged in the upper block-end mounting groove 241 and abuts against the groove wall thereof that is adjacent to the dividing wall 243 (see FIG. 11). Meanwhile, the projecting member (i.e., the second barrel-end mounting portion 237) of the metal barrel 23 extends into the lower block-end mounting groove 242 and ends up abutting against the groove wall thereof that is adjacent to the dividing wall 243 (see FIG. 11). However, depending on product requirements, the configuration of the first barrel-end mounting portion 236 and the second barrel-end mounting portion 237 is not limited to the structures discussed supra. In certain embodiments, in each terminal block 24, the horizontal width of the upper block-end mounting groove 241 can be different from the horizontal width of the lower block-end mounting groove 242, for example, in certain embodiments, the horizontal width of the upper block-end mounting groove 241 is smaller than the horizontal width of the lower block-end mounting groove 242, and the horizontal width of the first barrel-end mounting portion 236 is smaller than the horizontal width of the second barrel-end mounting portion 237, so as to produce a foolproof design that prevents the terminal block 24 from coupling with the corresponding lower barrel element 232 if the former is mounted into the latter in a wrong direction.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A connecting terminal divided from top to bottom into:
a fixing portion configured to be fixed to a transmission line;
an abutting portion configured to abut against an electrically conductive contact of a circuit board; and
a middle section configured to be connected to the fixing portion and the abutting portion, and provided with a plurality of bends to form a multi-section structure, wherein the multi-section structure has a plurality of extension sections,
wherein two of the extension sections that are spaced apart by a greatest horizontal distance therebetween define a projection extent; the fixing portion is completely within the projection extent and is close to one of the two extension sections; and a wire fixing space is formed between the fixing portion and the other of the two extension sections and is for receiving the transmission line.

2. The connecting terminal according to claim 1, wherein the plurality of extension sections include a plurality of vertical sections and at least one intermediate connecting section; each of the plurality of vertical sections extends substantially along a vertical axis, and an angle between each of the plurality of vertical sections and the vertical axis is equal to or less than 10 degrees; and each of the at least one intermediate connecting section connects two adjacent ones of the plurality of vertical sections.

3. The connecting terminal according to claim 2, wherein the middle section includes an upper connecting section connected between the fixing portion and an uppermost one of the plurality of vertical sections.

4. The connecting terminal according to claim 2, wherein the middle section includes a lower connecting section connected between the abutting portion and a lowermost one of the plurality of vertical sections.

5. The connecting terminal according to claim 1, wherein the fixing portion and the abutting portion are positioned to be passed through by a same vertical axis and in axial alignment in a three-dimensional space.

6. The connecting terminal according to claim 5, wherein the wire fixing space and the abutting portion are positioned to be passed through by a same vertical axis in the three-dimensional space.

7. The connecting terminal according to claim 1, wherein a vertical cross-sectional shape of the fixing portion extends substantially along a vertical axis.

8. The connecting terminal according to claim 1, wherein a vertical cross-sectional shape of the abutting portion extends substantially along a transverse axis or a longitudinal axis, and a bottom surface of the abutting portion is configured to abut against the electrically conductive contact.

9. The connecting terminal according to claim 1, wherein the abutting portion is completely within the projection extent.

10. A male connector comprising:
a male-end base;
at least one connecting terminal according to claim 1, wherein the connecting terminal is directly or indirectly fixed to the male-end base.

11. The male connector according to claim 10, wherein the male-end base includes a first base body and a second base body, the first base body is located under the second base body, and the first base body has a smaller cross-sectional area than the second base body.

12. The male connector according to claim 10, further comprising at least one metal barrel, wherein each of the at least one metal barrel is configured to be fixed to the male-end base, and a barrel space is formed in each of the at least one metal barrel and is for receiving at least one of the at least one connecting terminal.

13. The male connector according to claim 12, wherein each of the at least one metal barrel comprises:
an upper barrel element provided therein with an upper barrel space; and
a lower barrel element configured to be connected along a vertical axis with the upper barrel element, wherein the upper barrel element is at an upper position, the lower barrel element is at a lower position, a lower barrel space is provided in the lower barrel element, and the upper barrel space and the lower barrel space communicate with each other to form the barrel space.

14. A male connector assembly, comprising:
a transmission line;
the male connector according to claim 10, wherein the fixing portion of the connecting terminal is electrically connected to the transmission line.

15. The male connector assembly according to claim 14, wherein the transmission line comprises:
a center conductor configured to transmit electrical signals and be fixed to the fixing portion of the connecting terminal, and located in the wire fixing space;
a first insulating layer configured to wrap around, or cover an exterior of, the center conductor;
a metal braided layer provided on an exterior of the first insulating layer to provide grounding; and
a second insulating layer configured to wrap around, or cover an exterior of, the metal braided layer.
